(19) United States
(12) Patent Application Publication
(10) Pub. No.: US 2026/0309980 A1
(43) Pub. Date: Oct. 8, 2026

(54) High-Contrast Privacy Display in an Instrument Panel of a Vehicle

(71) Applicant: Bayerische Motoren Werke Aktiengesellschaft, Muenchen (DE)

(72) Inventor: Sebastian Takeshi LAMPEN, Tokyo (JP)

(21) Appl. No.: 19/476,230

(22) PCT Filed: Jun. 25, 2024
(86) PCT No.: PCT/DE2024/100566

§ 371 Date: Oct. 17, 2025

(30) Foreign Application Priority Data
Jul. 11, 2023 (DE) 10 2023 118 322.2

(51) Int. Cl. G02B 27/01; B60K 35/231; B60K 35/28; G02B 5/30

(52) U.S. Cl. CPC G02B 27/0101; B60K 35/231; B60K 35/28; G02B 5/3083; B60K 2360/164; B60K 2360/693; G02B 2027/013

(57) ABSTRACT

A privacy display includes an imaging device configured to generate a light beam having display content, and a cover panel that transmits the light beam and is arranged in a surface portion, facing a vehicle passenger on a front vehicle seat, of an instrument panel. The privacy display also includes a projection and/or imaging optical system, which is arranged in the beam path between the imaging device and the cover panel and is configured such that the light beam exits the cover panel directly towards an eyebox predetermined for the eyes of the passenger, and the display content is displayed to the passenger as a real or virtual image. The cover panel is dimmed by adding particles, by colouring or by tinting, and/or by a polarization filter such that it forms a dark or black image background for high-contrast display of the real or virtual image.

### BACKGROUND AND SUMMARY

The invention relates to a privacy display for installation in an instrument panel of a vehicle for generating a real image or a virtual image floating freely in the air for a vehicle occupant. The invention is also directed to a vehicle equipped therewith.

So-called head-up displays (HUD) are known for vehicles, which are used to show an image in the field of view of an occupant via reflection on a partially-transparent reflection pane, typically a windshield or a combiner pane separately provided for this purpose. In this way, for example, speed information and other useful navigation, warning, and vehicle operation notifications can be overlaid in the form of a virtual image on the real surroundings in front of the vehicle, which are observed by the driver or another occupant. For this purpose, for example, an HUD for the driver in classic design comprises a projection unit housed in the instrument panel, which generates a light beam bundle having desired display content and projects it in suitable shape and direction onto the windshield of the vehicle or onto a combiner pane arranged in front of it on the vehicle interior, from which it is reflected to the eyes of the driver or to a spatial area (eyebox) predetermined for them.

In order to read the display of a head-up display, the driver therefore does not have to look away from the road and also does not have to refocus strongly with a suitable design of the projection optical unit. However, it is not easy to display the HUD image in the transparent area of the windshield with sufficient brightness and high enough contrast even in high ambient brightness.

Head-up displays are also proposed in the prior art as front passenger entertainment or as driver entertainment during parking or autonomous driving. In addition to virtual image display, for example, the generation of a real image floating in the air for one or more observers by way of an imaging concave mirror is known in this case from CN 217821128 U, wherein the beam path leads via reflection on the windshield to the eyeboxes of a driver and a front passenger during the use in the vehicle.

It is the object of the present invention to specify an alternative and/or improved display device for a vehicle, which enables an improvement in relation to known devices, for example, with regard to the installation space, the contrast, the visibility, the image quality, and/or other aspects.

This object is achieved by a privacy display and by a vehicle equipped therewith according to the claimed invention. All refining features and effects mentioned for the privacy display in the claims and the following description also apply with reference to the vehicle, and vice versa.

According to a first aspect, a high-contrast privacy display is provided, which is designed for installation in an instrument panel of a vehicle. The vehicle can be a motor vehicle, but also any other land vehicle, aircraft, or water vehicle.

The privacy display comprises an image generator designed for generating a light beam bundle having desired display content (also called “projector light” herein) and a cover pane (also called cover glass) designed to transmit the light beam bundle. In principle, any imaging technology is suitable for the image generator, in particular a light-transmitting or light-emitting flatscreen display, a projector-based image generator, or a waveguide-based display. The cover pane is designed to be arranged in a surface section of the instrument panel which faces toward a vehicle occupant on a front vehicle seat, so that the cover pane is arranged with its surface directly opposite to the occupant in the installed state.

Furthermore, the privacy display comprises a projection and/or imaging optical unit arranged in the beam path between the image generator and the cover pane and designed such that the light beam bundle leaves the cover pane in an emission direction that leads directly (i.e. without further deflection surfaces) to a spatial area (eyebox) predetermined for the eyes of the mentioned occupant. The projection and/or imaging optical unit is designed here to display the display content to this occupant as a real image floating freely in the air in front of the cover pane (i.e. in the passenger compartment) or as a virtual image floating beyond the cover pane (i.e. in the interior of the instrument panel or still farther away). The occupant can see this image when they look in the direction of the cover pane.

In this case, the cover pane comprises a particle admixture, coloration, or tinting, and/or a polarization filter and is thus darkened to such an extent that it forms a dark or even black image background for a particularly high-contrast display of the real or virtual image. Since in the present case the cover pane having the interior of the instrument panel and the privacy display located behind it is used as the image background, the image contrast can be increased by its darkening. And since the image is not displayed against bright exterior surroundings of the vehicle, in contrast to the head-up display mentioned at the outset, perfect visibility can already be achieved using a significantly lower intensity of the projector light than in an HUD, so that in spite of a certain attenuation of the projector light by the darkened cover pane, a higher image contrast is achievable at the same time.

In other words, the cover pane is used due to its deliberate darkening as a contrast medium for displaying the real or virtual image with a desired contrast. At the same time, the view into the interior of the privacy display through the cover pane can thus be largely blocked to the vehicle occupants. Since the ambient light has to pass the cover pane twice in contrast to the projector light in order to eliminate the interior of the privacy display for the occupants, it can also be attenuated at least twice as strongly as the projector light by light-absorbing particles or a suitable polarization filter in the cover pane.

An eyebox is understood as usual as a spatial area from which the displayed real or virtual image is unrestrictedly visible. In other words, the light beam bundle is essentially restricted to this spatial area. Therefore, the generated image is only visible for that occupant whose eyes are located in the eyebox predetermined for this purpose, which does not go beyond the width of their vehicle seat, for example. On the one hand, confidential content (“privacy”) can be displayed to this occupant. On the other hand, other occupants, such as the driver, are not visually disturbed by this display, because they cannot see it.

One concept of the present invention is the integration of the projector (privacy display) presented herein in the instrument panel. The integration of a projector in the vehicle is difficult both because of installation space techniques and also in the sense of reflection freedom and the visibility with high ambient brightness. These difficulties can be overcome by the arrangement of the optical components proposed herein and via darkening of the exit aperture (cover pane) by particle admixture or a polarization filter. The privacy display presented herein has the advantage in relation to a head-up display, in which the image is overlaid on bright exterior surroundings of the vehicle, that here the cover pane having the interior of the instrument panel and the privacy display located behind it is used as the image background. The image brightness can thus be increased substantially independently of the ambient brightness and the contrast can also be significantly improved.

According to one embodiment, the mentioned polarization filter is designed as a circular polarizer, which is composed of a quarter-wave retarder facing toward the projection and/or imaging optical unit and a linear polarizer facing toward the occupant. The unpolarized ambient light incident from the outside on the cover pane is thus initially attenuated by half by the linear polarizer and then circularly polarized in the correspondingly aligned quarter-wave retarder. If this ambient light is reflected back in the interior of the privacy display toward the cover pane, it thus again has a linear polarization after the second passage through the quarter-wave retarder, but with a polarization direction rotated by 90° in relation to the transmission direction of the linear polarizer. The reflected ambient light is therefore blocked or absorbed by the linear polarizer, in other words completely extinguished. The blocking of the ambient light reflected in the interior of the privacy display contributes both to the mentioned contrast improvement of the displayed real or virtual image and to preventing the view of the occupants into the interior of the privacy display.

Ideally, the image generator is designed in this embodiment to generate the light beam bundle with a circular polarization such that after passage through the quarter-wave retarder it has a linear polarization transmitted by the linear polarizer and therefore can pass the polarization filter substantially unattenuated. Alternatively thereto, however, the projector light can also have a polarization, for example, which is not manipulated by the quarter-wave retarder. In this case, the projector light is linearly polarized parallel to the fast or slow axis of the quarter-wave retarder and is thus also transmitted by 50% by the linear polarizer, the transmission direction of which forms a 45° angle to these axes.

Alternatively, any other polarization filter can also be used in the cover pane, however, such as a linear polarizer that transmits projector light polarized in its transmission direction unattenuated, but in contrast blocks at least half of the unpolarized ambient light.

According to one embodiment, the projection and/or imaging optical unit comprises at least one concave mirror, which can be designed, for example, for a beam-deflecting, image-enlarging, and/or image-correcting effect. Alternatively or additionally, the projection and/or imaging optical unit can also comprise, for example, planar mirrors and other deflection elements for folding the beam path and/or lenses and other imaging elements for generating the real image or for defining the display properties of the virtual image.

In particular, the projection and/or imaging optical unit can in this case comprise two concave mirrors located directly opposite to one another in the beam path of the light beam bundle. This can be expedient for a particularly compact beam path and/or for particularly good imaging properties, above all for generating a real image.

According to one embodiment, the projection and/or imaging optical unit is designed to display the display content as a real image in an image plane floating in the air between the cover pane and eyebox. An orientation (in the sense of image inclination) of the floating image plane which is optimum for observing the generated image and is substantially independent from the surface geometry of the instrument panel and can therefore also significantly deviate therefrom can be achieved here by a suitable selection of the mutual arrangement and design of the image generator and the projection and/or imaging optical unit. In particular, a floating real image plane can thus be generated at positions which are not available for hard display surfaces due to the arm and leg freedom of the occupant required in the vehicle in front of their vehicle seat.

According to a further aspect, the above vehicle is provided. The spatial orientation terms used herein such as “above”, “below”, “lateral”, “horizontal”, “vertical”, etc. relate to the typical vehicle-fixed Cartesian coordinate system having longitudinal, transverse, and vertical axes of the vehicle perpendicular to one another.

The vehicle comprises a windshield, an instrument panel extending thereunder, and at least one front vehicle seat arranged opposite to the instrument panel. It is equipped with at least one privacy display of the type presented herein. Each of these privacy displays is integrated into the instrument panel here such that its cover pane forms a surface section of the instrument panel which faces toward a vehicle occupant on one of the front vehicle seats.

According to one embodiment, the cover pane is arranged in the instrument panel so that its user-side surface is flush with adjoining surface sections of the instrument panel. In other words, in this embodiment the user-side surface of the cover pane follows the surface shape of the instrument panel or forms its continuation.

In particular, one of the privacy displays can be arranged opposite to a front passenger seat and can be designed for use as front passenger entertainment. Alternatively or additionally, one of the privacy displays can be arranged opposite to a driver seat and can be designed, for example, for use as driver entertainment during autonomous driving or in the parked vehicle.

The above aspects of the invention and the embodiments and specific designs thereof are explained in more detail hereinafter on the basis of an example illustrated in the appended drawing. The drawing is to be understood as a solely schematic illustration of the fundamental optical design principle, i.e. as not to scale.

### BRIEF DESCRIPTION OF THE DRAWING

FIG. 1 shows a vertical longitudinal section through a detail of a vehicle having a privacy display according to an exemplary embodiment of the invention.

### DETAILED DESCRIPTION OF THE DRAWING

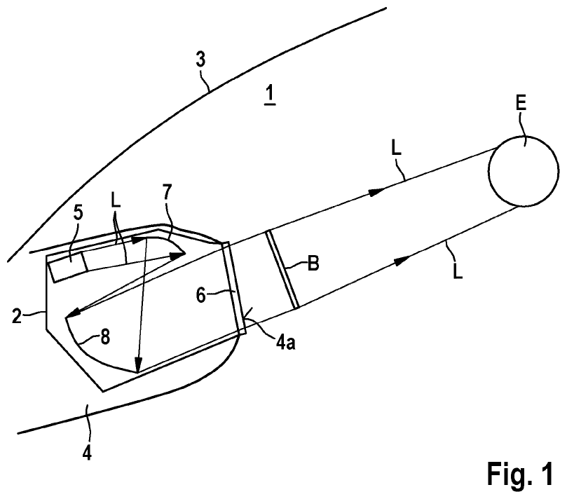

All of the various embodiments, alternatives, and specific design features of the privacy display and the vehicle according to the above aspects of the invention which are mentioned above in the description and in the following claims can be implemented in the example found in FIG. 1, in particular also alternatively or additionally to the features shown therein. They are therefore not all repeated once again hereinafter. This also applies accordingly to the above-mentioned term definitions and effects with respect to individual features shown in FIG. 1.

FIG. 1 shows a very simplified schematic longitudinal sectional view of an exemplary embodiment of a vehicle 1 having a privacy display 2 of the type presented herein. The vehicle 1 is a motor vehicle in this example, which is indicated in FIG. 1 only by its windshield 3 and an instrument panel 4 extending thereunder. As already mentioned, the spatial orientation terms such as “above”, “below”, “lateral”, “horizontal”, “vertical”, etc. relate to the typical vehicle-fixed Cartesian coordinate system having longitudinal, transverse, and vertical axes of the vehicle 1 perpendicular to one another.

The privacy display 2 is integrated in the interior of the instrument panel 4 and contains an image generator 5 designed to generate a light beam bundle L having desired display content and a cover pane 6 designed to transmit the light beam bundle L. The light beam bundle L (projector light) is only indicated in schematic form by its edge beams.

The cover pane 6 is formed in a surface section 4a of the instrument panel 4 which faces toward a vehicle occupant on a front vehicle seat (not shown), so that it is arranged having its surface directly opposite to the occupant. The occupant, in this example a front passenger, is only indicated by a spatial area E (eyebox) predetermined for their eyes or their head. The eyebox E is again solely symbolically outlined and is located in the area of the mentioned vehicle seat.

Furthermore, the privacy display 2 comprises a projection and/or imaging optical unit arranged in the beam path of the projector light L between the image generator 5 and the cover pane 6, which in this example comprises two concave mirrors 7 and 8 located directly opposite to one another. Solely by way of example, these are designed in FIG. 1 for the purpose of imaging the display content generated by the image generator 5 in a real image B floating freely in the air, which can be seen from the eyebox E of the occupant when looking in the direction of the cover pane 6.

An optimal location (in the sense of an image distance) and orientation (in the sense of an image inclination) of the floating image plane between the cover pane 6 and the eyebox E can be achieved here by a suitable selection of the mutual arrangement and design of the image generator 5 and the projection and/or imaging optical unit, which would not be possible using conventional display technologies such as flatscreen displays or head-up displays. In particular, the occupant can observe the real image B here in a floating image plane in a comfortable reading distance between their vehicle seat and the instrument panel 4 without their arm and leg freedom thus being restricted and without the image inclination depending on the geometry of the surface section 4a of the instrument panel 4. This can accordingly also be achieved alternatively for a virtual image display (not shown) beyond the cover pane 6.

In this case, the cover pane 6 is darkened by a particle admixture, coloration, or tinting and/or by an integrated polarization filter to such an extent that it forms a dark or even black image background for a particularly high-contrast display of the real image B. Since the cover pane 6 having the interior of the instrument panel 4 and the privacy display 2 located behind it is used as the image background, the image contrast can be increased by its darkening. And since the image, in contrast to the head-up display mentioned at the outset, is not displayed against bright external surroundings of the vehicle, perfect visibility can already be achieved with a significantly lower intensity of the projector light L than with an HUD, so that in spite of a certain attenuation of the projector light L by the darkened cover pane 6, a higher contrast is achievable at the same time. The view into the interior of the privacy display 2 through the cover pane 6 is substantially blocked at the same time to the vehicle occupants by this darkening.

In particular, the mentioned polarization filter can be designed as a circular polarizer, which is composed of a quarter-wave retarder (not illustrated) facing toward the concave mirror 8 and a linear polarizer (not illustrated) facing toward the eyebox E. The unpolarized ambient light incident from the outside on the cover pane 6 is thus initially attenuated by half by the linear polarizer and then circularly polarized in the correspondingly aligned quarter-wave retarder. If this ambient light is reflected back in the interior of the privacy display 2 toward the cover pane 6, it thus again has a linear polarization after the second passage through the quarter-wave retarder, but with a polarization direction rotated by 90° in relation to the transmission direction of the linear polarizer. The reflected ambient light is therefore completely extinguished by the linear polarizer. Ideally, the image generator 5 is designed here to generate the projection light L with a circular polarization such that after passage through the quarter-wave retarder it has a linear polarization transmitted by the linear polarizer and can therefore pass the polarization filter substantially unattenuated.

Reducing or blocking the ambient light reflected in the interior of the privacy display 2 contributes both to the mentioned contrast improvement of the real image B and also to preventing the view of the occupants into the interior of the privacy display 2. As already mentioned, the unpolarized ambient light can also be attenuated in the cover pane 6 using other types of polarization filters and/or also with other polarization properties of the projector light L in a significantly higher proportion than the projector light L.
LIST OF REFERENCE SIGNS
1 vehicle
2 privacy display
3 windshield
4 instrument panel
4a surface section of the instrument panel facing toward a vehicle occupant on a front vehicle seat
5 image generator
6 cover pane
7,8 concave mirrors facing toward one another
L light beam bundle, also called projector light
B real image floating in the air
E eyebox

1-9. (canceled)

10. A high-contrast privacy display for an instrument panel of a vehicle, the privacy display comprising:
an image generator configured to generate a light beam bundle having desired display content;
a cover pane configured to transmit the light beam bundle and to be arranged in a surface section of the instrument panel which faces toward a vehicle occupant on a front vehicle seat; and
a projection and/or imaging optical unit arranged in a beam path between the image generator and the cover pane and configured such that the light beam bundle leaves the cover pane directly in a direction of an eyebox predetermined for eyes of the vehicle occupant and the display content is displayed to the vehicle occupant as a real or virtual image floating in air in front of or behind the cover pane;
wherein the cover pane is darkened by a particle admixture, coloration, or tinting and/or by a polarization filter to such an extent that the cover pane forms a dark or black image background for a high-contrast display of the real or virtual image.

11. The privacy display according to claim 10, wherein
the particle admixture, coloration, or tinting and/or the polarization filter are configured to substantially prevent a view into an interior of the privacy display through the cover pane for vehicle occupants.

12. The privacy display according to claim 10, wherein
the polarization filter is configured as a circular polarizer, which is composed of a quarter-wave retarder facing toward the projection and/or imaging optical unit and a linear polarizer facing toward the vehicle occupant.

13. The privacy display according to claim 12, wherein the image generator is configured to output the light beam bundle with a circular polarization such that after passage through the quarter-wave retarder, the light beam bundle has a linear polarization transmitted by the linear polarizer.

14. The privacy display according to claim 10, wherein
the projection and/or imaging optical unit comprises at least one concave mirror.

15. The privacy display according to claim 14, wherein
the projection and/or imaging optical unit comprises two concave mirrors directly opposite to one another in a beam path of the light beam bundle.

16. The privacy display according to claim 10, wherein
the projection and/or imaging optical unit is configured to display the display content as the real image in an image plane floating in the air between the cover pane and the eyebox; and
the image plane has a spatial orientation significantly deviating from the surface section of the instrument panel.

17. A motor vehicle having longitudinal, transverse, and vertical axes of a vehicle-fixed Cartesian coordinate system perpendicular to one another, the motor vehicle comprising:
a windshield, the instrument panel extending under the windshield, and the front vehicle seat arranged opposite to the instrument panel; and
at least one privacy display according to claim 10, wherein the at least one privacy display is integrated into the instrument panel so that the cover pane forms the surface section of the instrument panel, which faces toward the vehicle occupant on the front vehicle seat.

18. The vehicle according to claim 17, wherein
the cover pane is arranged in the instrument panel so that a user-side surface of the cover pane is flush with adjoining surface sections of the instrument panel.

19. The vehicle according to claim 17, wherein
a first one of the at least one privacy display is arranged opposite to a front passenger seat and is configured for front passenger entertainment; and/or
a second one of the at least one privacy display is arranged opposite to a driver seat and is configured for driver entertainment during autonomous driving or in a parked state of the vehicle.
